(19) United States
(12) Patent Application Publication
(10) Pub. No.: US 2026/0141828 A1
(43) Pub. Date: May 21, 2026

(54) WATERPROOF AND RUSTPROOF AND ANTI-TANGLING POSITIONING DEVICE FOR FLAGPOLES

(71) Applicant: Weihai Fangtan Composite Materials Co., Ltd., Weihai (CN)

(72) Inventor: Yuping Sun, Weihai (CN)

(21) Appl. No.: 18/950,846

(22) Filed: Nov. 18, 2024

(51) Int. Cl. G09F 17/00

(52) U.S. Cl. CPC G09F 17/0091; G09F 2017/0025

(57) ABSTRACT

A waterproof, rustproof, and anti-tangling positioning device for flagpoles, comprising a positioning lock, a core shaft, a bearing, a bearing seat and a waterproof platform, the positioning lock is detachably connected to one end of the core shaft, the bearing is sleeved on an inner side of the other end of the core shaft, the bearing seat is sleeved on an outer side of the bearing, the waterproof platform is detachably connected to one end of the core shaft away from the positioning lock, the waterproof platform is arranged on an outer side of the bearing and the bearing seat. The invention combines multiple structures such as the positioning lock, the core shaft, the bearing, the bearing seat and the waterproof platform, and has good waterproof, rustproof and anti-tangling properties; the above structure can be applied to flags of different sizes, increasing the service life and aesthetics of products.

### TECHNICAL FIELD

The invention relates to the technical field of auxiliary components for flagpoles, in particular to a waterproof, rustproof, and anti-tangling positioning device for flagpoles.

### BACKGROUND ART

Flagpoles are increasingly used in various scenarios in people’s lives, including applications in building structures, courtyards, outdoors, and vehicles. With their widespread use, numerous problems may arise, such as rusting, flag tangling, and the inability to manually adjust the device for different flag sizes.

In order to solve the above technical problems, a waterproof, rustproof, and anti-tangling positioning device for flagpoles has become an urgent problem to be solved by the whole society.

### SUMMARY OF THE INVENTION

In order to solve the above problems, the invention provides the following technical scheme: a waterproof, rustproof, and anti-tangling positioning device for flagpoles, comprising a positioning lock, a core shaft, a bearing, a bearing seat and a waterproof platform, the positioning lock is detachably connected to one end of the core shaft, the bearing is sleeved on an inner side of the other end of the core shaft, the bearing seat is sleeved on an outer side of the bearing, the waterproof platform is detachably connected to one end of the core shaft away from the positioning lock, the waterproof platform is arranged on an outer side of the bearing and the bearing seat.

Further, a first threaded connection part is arranged at one end of the core shaft, and a second threaded connection part is arranged at the other end thereof, the positioning lock is threadedly connected to the first threaded connection part on the core shaft, and the waterproof platform is threadedly connected to the second threaded connection part on the core shaft.

Further, an outer peripheral surface of the core shaft that cooperates with the bearing is set smoothly.

Further, a circular extension plate is arranged on an outer peripheral surface of a middle part of the core shaft.

Further, an outer peripheral surface of the positioning lock is evenly distributed with anti-skid patterns.

Further, the positioning lock 1, the core shaft, the bearing, the bearing seat and the waterproof platform are coaxially arranged.

Further, an inner side of the bearing seat is provided with a fitting groove body that matches with the bearing, facilitating the connection and fitting with the bearing.

Compared with the prior art, the invention has the following advantages:

the invention combines multiple structures such as the positioning lock, the core shaft, the bearing, the bearing seat and the waterproof platform, and has good waterproof, rustproof and anti-tangling properties; the above structure can be applied to flags of different sizes, greatly increasing the service life and aesthetics of the product;

the invention adopts the waterproof platform, so that the entire device has good waterproof performance and prolongs the service life of the entire device. The invention adds the bearing seat and other structures on the outer side of the bearing, which effectively prolongs the service life of the bearing, enhances the smoothness of the bearing, and solves the problems of entangling the flag and affecting aesthetics due to rust formation after long-term outdoor use.

### BRIEF DESCRIPTION OF ACCOMPANY DRAWINGS

FIG. 1 is a schematic diagram of the exploded structure of the waterproof, rustproof, and anti-tangling positioning device for flagpoles of the invention.

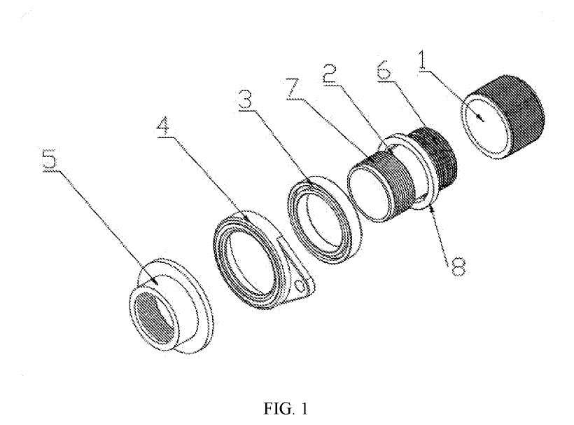

FIG. 2 is a schematic diagram of the structures of the bearing seat and the connecting carabiner.

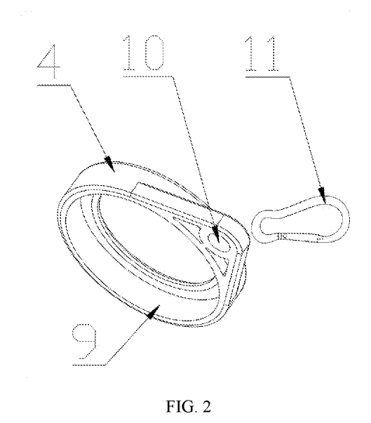

In the figures: 1 positioning lock, 2 core shaft, 3 bearing, 4 bearing seat, 5 waterproof platform, 6 first threaded connection part, 7 second threaded connection part, 8 circular extension plate, 9 fitting groove body, 10 circular hole, 11 connecting carabiner.

### SPECIFIC EMBODIMENT OF THE INVENTION

The invention will be further described in detail below with reference to the accompanying drawings.

In combination with the accompanying drawings, the invention is described in detail.

When the invention is specifically implemented, the invention provides a waterproof, rustproof, and anti-tangling positioning device for flagpoles, comprising a positioning lock 1, a core shaft 2, a bearing 3, a bearing seat 4 and a waterproof platform 5, the positioning lock 1 is detachably connected to one end of the core shaft 2, the bearing 3 is sleeved on an inner side of the other end of the core shaft 2, the bearing seat 4 is sleeved on an outer side of the bearing 3, the waterproof platform 5 is detachably connected to one end of the core shaft 2 away from the positioning lock 1, the waterproof platform 5 is arranged on an outer side of the bearing 3 and the bearing seat 4.

### Embodiment:

during the assembly of this invention, the core shaft 2 is locked onto a flagpole, the positioning lock 1 can be directly threaded onto one end of the core shaft, the bearing 3 is sleeved on the other end of the core shaft 2, and the bearing seat 4 is sleeved on the outer side of the bearing 3, the waterproof platform 5 is threaded onto the other end of the core shaft 2; when the flagpole is locked in place, during rainy or snowy weather, the waterproof platform 5 can drain away water; in order to prevent rusting of the middle bearing, the bearing seat 4 is arranged on the periphery, which effectively prolongs the lifespan and enhances the smoothness of the bearing 3, and solves the problems of entangling the flag and affecting aesthetics due to rust formation after long-term outdoor use.

Wherein, both ends of the core shaft 2 are provided with threads; after the waterproof platform 5 is installed, it can be glued and fixed on the core shaft 2 to prevent two-way rotation.

The waterproof platform 5, the bearing seat 4, and core shaft 2 are all made of polyoxymethylene (POM) and nylon materials, which have the following advantages:

1. high mechanical strength and rigidity: they will not be damaged or deformed after long-term use, enhancing the practicality of the entire device.

2. good wear resistance and self-lubrication: they have a low wear coefficient and excellent wear resistance, which can increase the lifespan of the entire device.

3. waterproof and moisture-proof: they exhibit good stability.

In order to facilitate the connection between the positioning lock and the waterproof platform, a first threaded connection part 6 is arranged at one end of the core shaft 2, and a second threaded connection part 7 is arranged at the other end thereof, the positioning lock 1 is threadedly connected to the first threaded connection part 6 on the core shaft 2, and the waterproof platform 5 is threadedly connected to the second threaded connection part 7 on the core shaft 2. Through the setting of the positioning lock, the above device can be locked and connected to the flagpole, which increases the stability of the connection between the above device and the flagpole.

As a further elaboration of the invention, an outer peripheral surface of the core shaft 2 that cooperates with the bearing 3 is set smoothly.

As a further elaboration of the invention, a circular extension plate 8 is arranged on an outer peripheral surface of a middle part of the core shaft 2. The above circular extension plate is used to separate the positioning lock 1 and the bearing 3, and plays a role of separation.

As a further elaboration of the invention, an outer peripheral surface of the positioning lock 1 is evenly distributed with anti-skid patterns. The setting of the anti-skid patterns facilitates the installation and disassembly of the positioning lock.

As a further elaboration of the invention, the positioning lock 1, the core shaft 2, the bearing 3, the bearing seat 4 and the waterproof platform 5 are coaxially arranged.

As a further elaboration of the invention, an inner side of the bearing seat 4 is provided with a fitting groove body 9 that matches with the bearing 3, facilitating the connection and fitting with the bearing. The setting of the above structure facilitates the positioning of the bearing seat during installation, making the entire structure easy to install and disassemble. The bearing seat serves to protect the bearing and ensure smooth operation.

As a further elaboration of the invention, the bearing seat 4 is provided with a circular hole 10, and a connecting carabiner 11 is arranged on the circular hole 10. The structure of the connecting carabiner facilitates the hanging of flags.

1. A waterproof, rustproof, and anti-tangling positioning device for flagpoles, comprising a positioning lock, a core shaft, a bearing, a bearing seat and a waterproof platform, the positioning lock is detachably connected to one end of the core shaft, the bearing is sleeved on an inner side of the other end of the core shaft, the bearing seat is sleeved on an outer side of the bearing, the waterproof platform is detachably connected to one end of the core shaft away from the positioning lock, the waterproof platform is arranged on an outer side of the bearing and the bearing seat.

2. The waterproof, rustproof, and anti-tangling positioning device for flagpoles of claim 1, wherein a first threaded connection part is arranged at one end of the core shaft, and a second threaded connection part is arranged at the other end thereof, the positioning lock is threadedly connected to the first threaded connection part on the core shaft, and the waterproof platform is threadedly connected to the second threaded connection part on the core shaft.

3. The waterproof, rustproof, and anti-tangling positioning device for flagpoles of claim 2, wherein an outer peripheral surface of the core shaft that cooperates with the bearing is set smoothly.

4. The waterproof, rustproof, and anti-tangling positioning device for flagpoles of claim 1, wherein a circular extension plate is arranged on an outer peripheral surface of a middle part of the core shaft.

5. The waterproof, rustproof, and anti-tangling positioning device for flagpoles of claim 1, wherein an outer peripheral surface of the positioning lock is evenly distributed with anti-skid patterns.

6. The waterproof, rustproof, and anti-tangling positioning device for flagpoles of claim 1, wherein the positioning lock, the core shaft, the bearing, the bearing seat and the waterproof platform are coaxially arranged.

7. The waterproof, rustproof, and anti-tangling positioning device for flagpoles of claim 1, wherein an inner side of the bearing seat is provided with a fitting groove body that matches with the bearing, facilitating the connection and fitting with the bearing.

8. The waterproof, rustproof, and anti-tangling positioning device for flagpoles of claim 1, wherein the bearing seat is provided with a circular hole, and a connecting carabiner is arranged on the circular hole.
